(19) United States
(12) Patent Application Publication
(10) Pub. No.: US 2009/0261216 A1
(43) Pub. Date: Oct. 22, 2009

(54) SUPPORT MECHANISM AND PORTABLE ELECTRONIC DEVICE USING THE SAME

(75) Inventors: MU-WEN YANG, Shindian (TW); CHIH-CHIANG CHANG, Shindian (TW); CHIA-WEI HU, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/327,446

(22) Filed: Dec. 3, 2008

(30) Foreign Application Priority Data
Apr. 22, 2008 (CN) 200810301253.7

(51) Int. Cl. F16M 11/38; G06F 3/041

(52) U.S. Cl. 248/168; 345/173

(57) ABSTRACT

A support mechanism (20) for a portable electronic device (100) is provided. The support mechanism (20) includes two legs (22) and a connecting bracket (24). The two legs (22) is pivotally coupled to the portable electronic device (100). The connecting bracket (24) includes a resisting shoulder (242) and two support shoulder (244), an end of each support shoulder (244) is pivotally coupled with the legs (22), and another end of each support shoulder (244) is fixed with the resisting shoulder (242).

### BACKGROUND

1. Field of the Invention

The present invention relates to support mechanisms, particularly to support mechanisms used with portable electronic devices.

2. Description of Related Art

Portable electronic devices with displays, especially portable Audio/Video products are widely used. Considering consumers' requirements for multiple-angled displays, some portable electronic devices have brackets fixed to them. The portable electronic device can “sit” on the desk by propping up the bracket. Thus, users can have a comfortable view of the display.

However, existing portable electronic products cannot have the length of their support mechanism adjusted. Therefore, the supporting angle of the portable electronic product cannot be adjusted to satisfy such demands from the consumers.

Therefore, there is room for improvement within the art.

### BRIEF DESCRIPTION OF THE DRAWINGS

Many aspects of the exemplary support mechanism can be better understood with reference to the following drawings. These drawings are not necessarily drawn to scale, the emphasis instead being placed upon clearly illustrating the principles of the present support mechanism and portable electronic device. Moreover, in the drawings like reference numerals designate corresponding parts throughout the several views. Wherever possible, the same reference numbers are used throughout the drawings to refer to the same or like elements of an embodiment.

FIG. 1 illustrates, in perspective view, a portable electronic device and associated support mechanism according to the exemplary invention. FIG. 2 illustrates, in perspective view, the portable electronic device and associated support mechanism of FIG. 1 with the support mechanism in an open position.

FIG. 3 illustrates, in exploded perspective view, elements of the portable electronic device and the support mechanism of FIGS. 1-2, showing one aspect thereof.

FIG. 4 illustrates, in exploded perspective view, elements of the portable electronic device and the support mechanism of FIGS. 3, showing another aspect thereof.

### DETAILED DESCRIPTION OF THE EXEMPLARY EMBODIMENTS

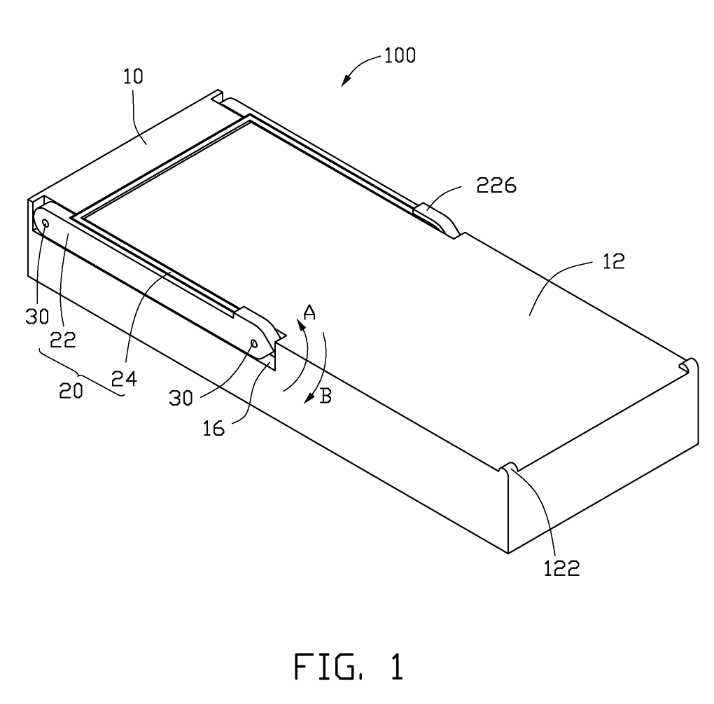

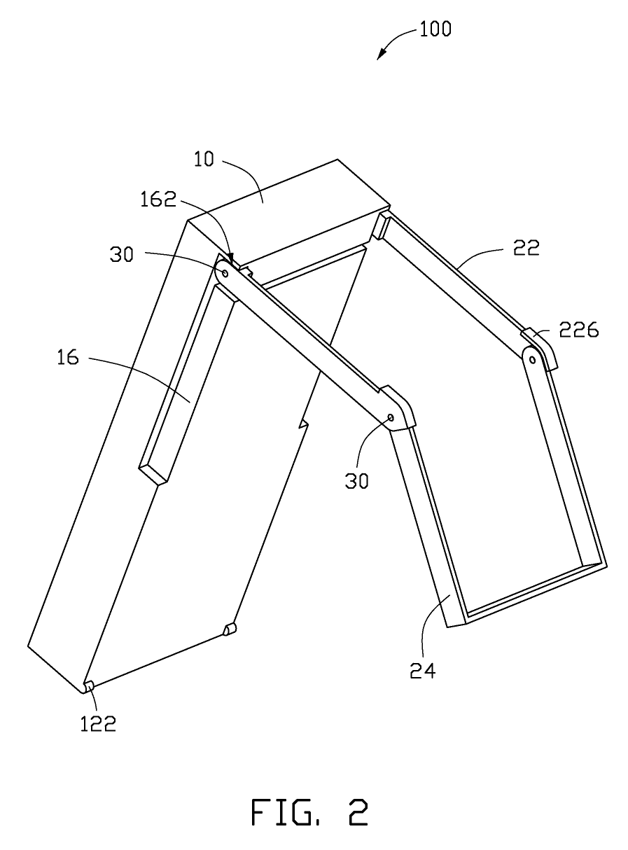

FIG. 1 shows an example of a portable electronic device utilizing the exemplary invention. FIG. 1 shows a back view of the device 100 including a body member 10 where a support mechanism 20 is configured. In FIG. 1, the support mechanism 20 is in a closed position for convenient handling. As will be described and illustrated below, the support mechanism 20 may also be pivotally adjusted to an open position to support the device 100 on a supporting surface (As shown in FIG. 2).

The body member 10 includes a back surface 12, to which the support mechanism 20 is attached. The rear surface 12 defines a recess 16 having a size corresponding to the size of, and for accommodating, the support mechanism 20. When the support mechanism 20 is in the closed position (FIG. 1), the support mechanism 20 is received in the recess 16.

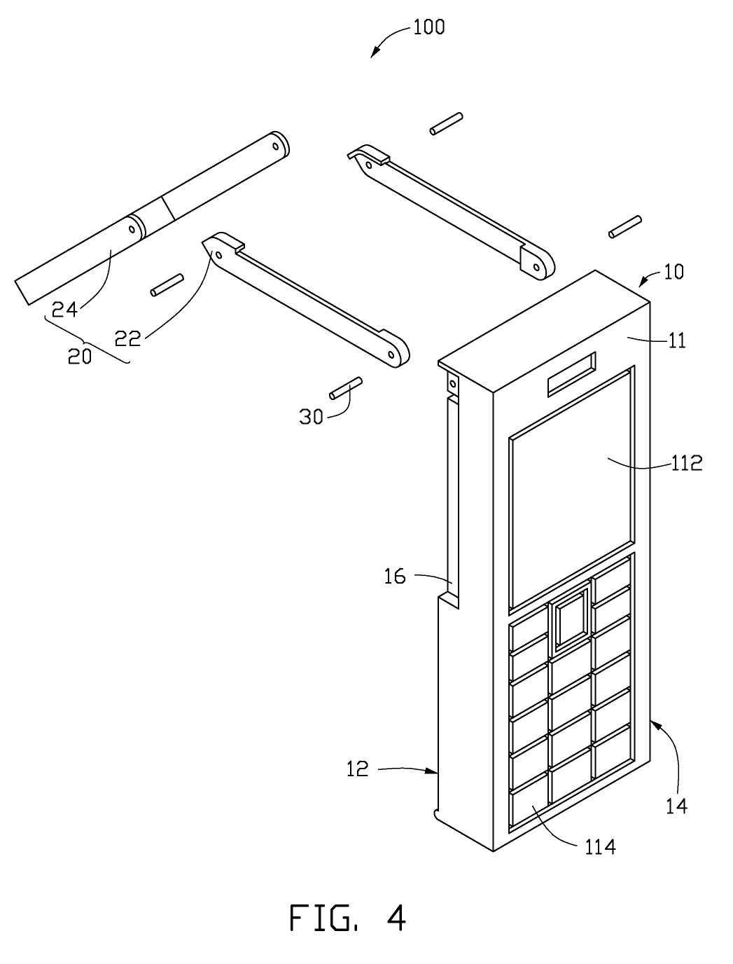

Referring to FIG. 4, the body member 10 further may includes a display 112 and a keypad 114 on a front surface 11, and other such elements necessary or desirable to the operation of the device 100, but not necessary for the description of the exemplary invention.

The support mechanism 20 includes two legs 22 and a connecting bracket 24. A first end 222 of each leg 22 is pivotally coupled to the body member 10 by two pivot pegs 30. A second end 224 of each leg 22, opposite to the first end 222, is pivotally coupled to the connecting bracket 24 by another two pivot pegs 30. When the support mechanism 20 is in the closed position, each leg 22 and connecting bracket 24 is substantially parallel to the back surface 12 of the body member 10. In this closed position each leg 22 with a elongate member 226 and the back surface 12 with two protrusions 122 cooperatively function as a stand to support the mobile phone 100 flat on a desk or other surface, while avoiding the back surface 12 from directly contacting the supporting surface

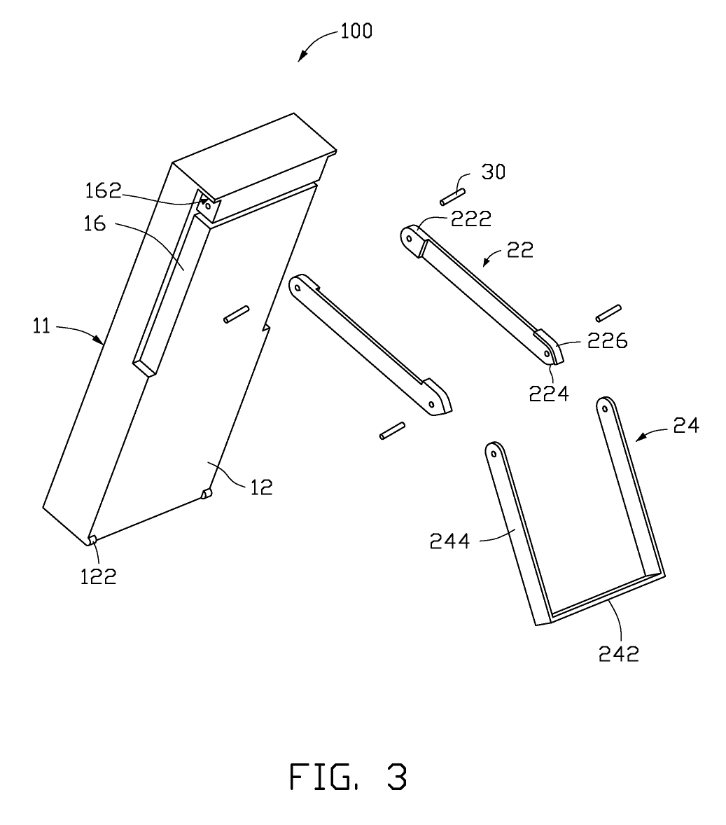

Referring to FIG. 2, each leg 22 includes the elongate member 226 which, in the opened position, forms a limiting portion for limiting rotation of the connecting bracket 24 relative the legs 22. Referring to FIG. 3, the connecting bracket 24 is substantially U-shaped and has a resisting shoulder 242 and two support shoulders 244, an end of each support shoulder 244 is pivotally coupled with the leg 22, and another end of each support shoulder 244 is fixed with the resisting shoulder 242.

Referring to FIG. 1, the following discussion describes the functional relationship between the supporting mechanism 20 and the body member 10. The legs 22 are rotated about the body member 10 as indicated by the arrow A. The legs 22 are rotated in this manner until the legs 22 bear against a sidewall 162 of the body member 10. The connecting bracket 24 is then rotated about the legs 22 in the direction indicated by the arrow B. As the connecting bracket 24 is rotated in this manner, the end of the connecting bracket 24 coupled with the legs 22 bears against the elongate member 226 (As shown in FIG. 2) so the support mechanism 20 provide support of the body member 10 on a support plane. The length of the support mechanism 20 can be regulated by rotating the legs 22 and the connecting bracket 24 so the supporting angle of the device 100 can be changed to satisfy the demand from the consumers.

What is claimed is:

1. A support mechanism for a portable electronic device comprising:
two legs pivotally coupled to the portable electronic device; and
a connecting bracket including a resisting shoulder and two support shoulders, an end of each support shoulder pivotally coupled with the legs, and another end of each support shoulder fixed to the resisting shoulder.

2. The support mechanism as claimed in claim 1, wherein each the leg is coupled to the portable electronic device.

3. The support mechanism as claimed in claim 1, wherein each support shoulder is pivotally coupled with the legs.

4. The support mechanism as claimed in claim 1, wherein each leg has an elongate member for limiting the rotation angle of the connecting bracket relative to the legs.

5. The support mechanism as claimed in claim 1, wherein the portable electronic device has a back surface having a plurality of protrusions protruding therefrom.

6. A portable electronic device comprising:
a display;
a body member, the display being disposed on the body member; and
a support mechanism comprising:
two legs pivotally coupled to the body member; and
a connecting bracket including a resisting shoulder and two support shoulders, an end of each support shoulder pivotally coupled with the legs, and another end of each support shoulder fixed to the resisting shoulder.

7. The portable electronic device as claimed in claim 6, wherein the body member has a recess accommodating the support mechanism.

8. The portable electronic device as claimed in claim 6, wherein each the leg is pivotally coupled to the body member.

9. The portable electronic device as claimed in claim 6, wherein each the support shoulder is pivotally coupled to the legs.

10. The portable electronic device as claimed in claim 6, wherein each leg has an elongate member for limiting the rotation angle of the connecting bracket relative to the legs.

11. The portable electronic device as claimed in claim 6, wherein the body member has a back surface having a plurality of protrusions protruding therefrom.
